(19) United States
(12) Patent Application Publication
(10) Pub. No.: US 2021/0126562 A1
(43) Pub. Date: Apr. 29, 2021

(54) APPARATUS AND METHOD OF TORQUE-BOOST DUAL-MOTOR SYSTEM

(71) Applicant: Massachusetts Institute of Technology, Cambridge, MA (US)

(72) Inventors: Haruhiko Harry Asada, Lincoln, MA (US); John Bell, Greenville, NC (US)

(73) Assignee: Massachusetts Institute of Technology, Cambridge, MA (US)

(21) Appl. No.: 17/079,391

(22) Filed: Oct. 23, 2020

Related U.S. Application Data
(60) Provisional application No. 62/925,434, filed on Oct. 24, 2019.

(51) Int. Cl. H02P 5/747

(52) U.S. Cl. CPC H02P 5/747

(57) ABSTRACT

Embodiments disclosed herein include a first motor having a high gear ratio, a second motor having a low gear ratio, and a drive shaft, the first and second motors being connected to a load via the drift shaft. The motor system is arranged to at least one of electrically and mechanically disconnect the first motor when a speed of the first motor reaches a threshold speed such that the first motor does not act as a generator and consume mechanical power. In some embodiments, the first motor is a torque booster and the second motor is a high speed motor. The first motor may be electrically disconnected via one or more relays, couplers, and additional switching semiconductors. The first motor may be mechanically disconnected via a clutch.

### CROSS-REFERENCE TO RELATED APPLICATIONS

This application claims the benefit under 35 U.S.C. § 119(e) to U.S. Provisional Application Ser. No. 62/925,434, filed Oct. 24, 2019, the contents of which are incorporated herein in its entirety.

### FIELD

The disclosed embodiments are generally directed to motor systems, such as actuators.

### BACKGROUND

Actuators are one of the key components in a broad range of industries and applications, such as robotics, automobiles, and mechanical systems. Electric motors and power electronics have shown significant technological progress, yet some basic drawbacks have still not been solved.

### SUMMARY

According to one embodiment, a motor system includes a first motor having a first gear ratio, a second motor having a second gear ratio lower than the first gear ratio, and a drive shaft, the first and second motors being connected to an output load via the drive shaft. The motor system is arranged to electrically and/or mechanically disconnect the first motor when a speed of the first motor is greater than or equal to a threshold speed.

According to another embodiment, an electric motor system includes a first motor having a first gear ratio and driven via a first drive amplifier, a second motor having a second gear ratio lower than the first gear ratio, the second motor being driven via a second drive amplifier, and a drive shaft, wherein the first and second motors are connected to an output load via the drive shaft. The motor system is arranged to measure an output shaft velocity and electrically disconnect the first motor when an output speed is greater than or equal to a threshold speed.

According to another embodiment, a method of operating a motor system having a first motor with a high gear ratio, a second motor with a low gear ratio, and a drive shaft, the first and second motors being connected to an output load via the drive shaft is disclosed. The method includes electrically and/or mechanically disconnecting the first motor when a speed of the first motor is greater than or equal to a threshold speed.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A and 1B illustrate two actions a legged assistive robot needs to accomplish low speed/high torque lifting (FIG. 1A) and high-speed/low torque foot placement for fall catching (FIG. 1B).

FIG. 2 illustrates examples of high torque and high-speed actions of an all-electric excavator;

FIG. 3 illustrates a torque-speed plot and power-speed plot for a single DC motor;

FIG. 4 is a dual-motor system according to embodiments of the present disclosure;

FIG. 5 is a dual-motor system according to other embodiments;

FIG. 6 illustrates electrical disconnection of a torque booster of a dual-motor system according to some embodiments;

FIG. 7 illustrates electrical disconnection of a torque booster of a dual-motor system according to other embodiments;

FIG. 8 illustrates electrical disconnection of a torque booster of a dual-motor system according to still other embodiments;

FIG. 9 shows a dual-motor system according to some embodiments;

FIG. 10 illustrates a dual-motor system according to other embodiments; and

FIG. 11 illustrates a dual-motor system to still other embodiments.

### DETAILED DESCRIPTION

In general, an electric motor produces its highest output power when spinning at 50% of its maximum speed while generating 50% of its maximum torque. The output power goes down and efficiency becomes low when generating a high torque at a zero or almost zero speed. In addition, output power and efficiency may become low when spinning at a high speed with zero or almost zero torque. As will be appreciated, there are many applications where electric motors are required to operate at a low speed with a high torque load or at a high speed with a low torque load. The inventors have recognized that in such applications, electric motors are used inefficiently and are producing limited output power.

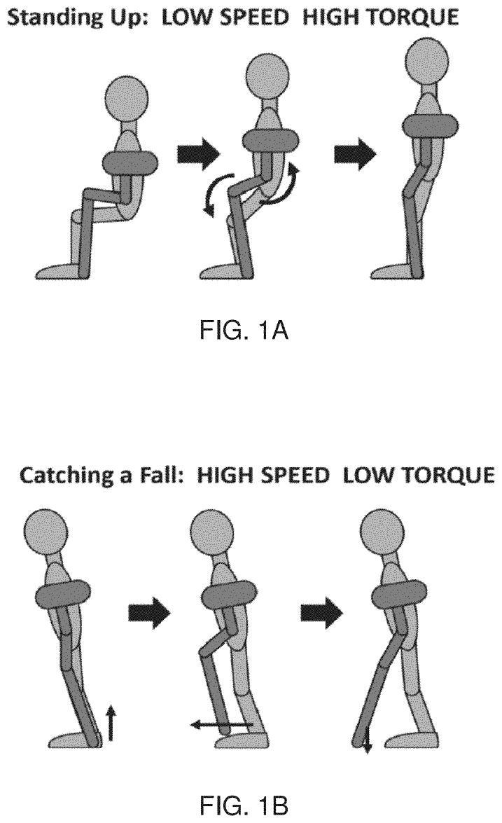

Legged robots are one such example of this inefficiency. As shown in FIGS. 1A and 1B, a biped robot, for example, may be used to assist an individual having difficulties in standing up from a chair (FIG. 1A) and from walking (FIG. 1B). As illustrated in these views, there are extreme load conditions under which actuators must work. The first is to assist the individuals transition from a seated to standing posture. The second is to catch the person's fall. For the seated-standing transition shown in FIG. 1A, the robot may supplement the individual's own strength in supporting their weight during the motion of rising. In some implementations, this motion is relatively slow, such as on the order of 10 RPM, but must carry a large amount of torque, such as on the order of 200 N-m. In contrast, for fall-catching (see FIG. 1B), a significantly faster motion is required to detach, move, and place a foot of the robot in a position that will catch the individual. During this foot placement action, the actuators may need to move much faster, such as on the order of 200 RPM, but may need only support the weight and inertia of the leg itself. Thus, the robot must bear a large gravity load once its leg touches the ground, where the required speed is almost zero. On the other hand, the leg must move quickly to step forward once it detaches the ground, where the load is small while moving through air. The inventors have recognized that if a single motor with a particular gear ratio is used, the motor must be a large high-power motor, which is heavy, bulky and, as noted, inefficient.

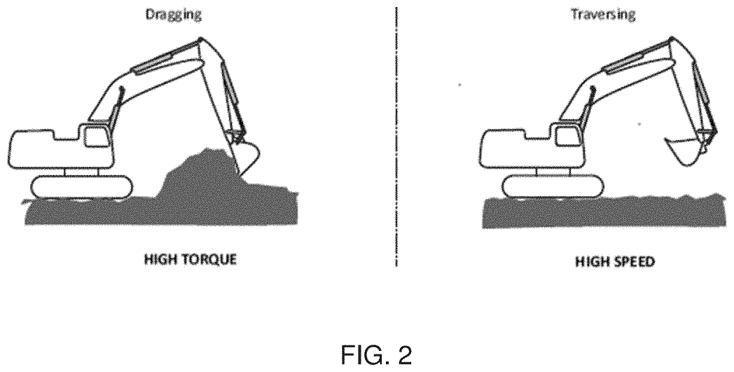

Another example of inefficiency is an all-electric excavator (see FIG. 2). An electric motor used for activating the arm and boom of an excavator, for example, must generate a large torque once its bucket digs the ground, where the speed is relatively low. On the other hand, the electric motor must move the arm and boom quickly when moving through the air, where the load is small.

In case of electric cars, still another example, efficiency becomes low under two extreme speed conditions, extremely low speed and high speed, unless a gearshift is involved. Wheel motors, in particular, have no physical space for placing a gearshift mechanism. In consequence it is difficult to cover a wide speed range efficiently.

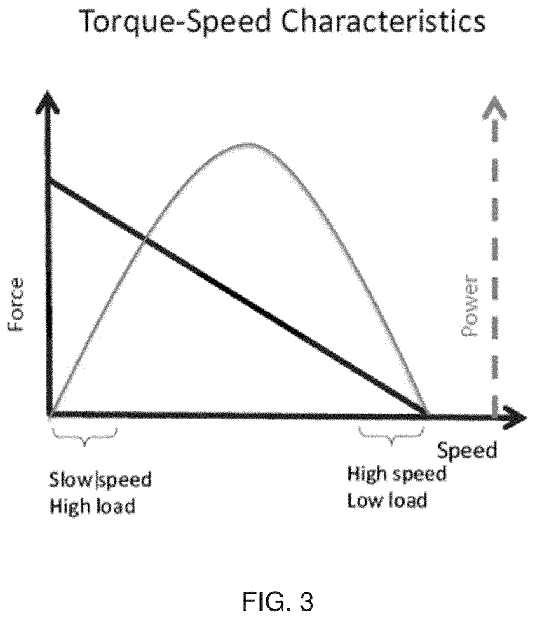

As shown in FIG. 3, the torque-speed-output power diagram indicates that, despite its high output-power capacity, the actuator is operated at the speed ranges that are away from the optimal speed for producing the highest power. At the two extreme load conditions, an almost zero speed and the fastest speed, the net output power is only a few percent of the highest power. As shown in this view, the point of maximum power is about half the no-load speed, which is near neither of the target operation zones.

Dual-motor actuators with two geared motors having different gear ratios have been studied to overcome the low efficiency problem experienced by a single motor with a single, fixed gearing. In such applications, the two motors may be connected to a common load and are mechanically “switched” between two different speed ranges. For example, planetary gearing has been used to connect two actuators to add the velocities of the two motors. At high speed both motors contribute to generate a high-speed rotation, while at low-speed and high-torque operation, a mechanical brake is used to clamp the motor with a low gear ratio so that a large torque load does not act on the high-speed low-torque motor. In this arrangement, relative gear ratios of over 40 have been achieved with the use of a planetary gear and a brake. Another approach to dual-motor actuator design is to add two output torques from both motors. At low speeds both motors connected to the same output shaft contribute to the common load together. Specifically, the motor with a high gear ratio, called a torque booster, contributes more to generating a high torque. At high speeds, the torque booster cannot catch up with the high-speed motor. Instead, the torque booster impedes the high-speed operation. To prevent the torque booster from impeding the high-speed operation, a one-way clutch may be inserted between the torque booster and the common load, so that the torque may be transmitted only from the torque booster towards the load, and not the other way around.

The inventors have recognized that such dual-motor designs may be applicable only to cases where the direction of rotation is never reversed. In other words, these designs only work for one-way motion. In contrast, a dual wheel motor developed for electric cars, for example, uses two electric motors with diverse gear ratios, where the high gear ratio motor is connected to its load through a unidirectional clutch. The unidirectional clutch allows the system to disengage the high-gear ratio motor when spinning at high speeds. However, it works only for one-directional operation. The unidirectional clutch mechanism would not work when the car is moving backward.

In view of the above, the inventors have recognized that in many robotic and mechatronic applications, a single geared motor with a fixed gear ratio is unable to cover the two extreme load conditions. The inventors have also recognized the benefits of having a dual motor actuator with two electric motors having different gear ratios and disconnecting the motor with the higher rear ratio such that the motor does not act as a generator consuming energy.

For example, in some embodiments of the present disclosure, the dual motor may include a motor with a higher gear ratio that produces a high torque and a motor with a lower gear ratio that is able to turn on quickly. In some embodiments, as speed increases, the motor with the higher rear ratio cannot spin very fast and may generate a reverse current, thereby consuming mechanical power as a generator. The inventors have recognized the benefit of disconnecting the torque booster when the torque booster reaches a threshold speed such that the torque booster does not act as a generator. For example, the torque booster may be disconnected when the speed of the torque booster is greater than or equal to a threshold speed. In some embodiments, the torque booster may be electrically disconnected such that the torque booster is isolated from whatever is powering it. For example, the torque booster may be electrically disconnected from a drive amplifier. In such embodiments, switching between a low speed/high torque and a high speed/low torque operation may be performed via only electric switches. As will be appreciated, in such embodiments, the motors may remain physically connected to one another even though they are electrically disconnected.

In other embodiments, the torque booster also may be mechanically disconnected such as via a clutch (e.g., a centripetal clutch) or a brake. As with the above, the torque booster may be mechanically disconnected from whatever is powering it and/or from the lower gear ratio motor, also referred to as the speed motor, when the torque booster reaches (e.g., is greater than or equal to) the threshold speed such that the torque booster does not act as a generator consuming mechanical power.

Accordingly, embodiments disclosed herein include an electric motor actuator system having two motors, a first motor having a high gear ratio and a second motor having a low gear ratio. The system may include at least one gearing and driving electronics. In some embodiments, the first and second motors may be connected to the same output load through a drive shaft. For example, in some embodiments, the motors may be directly geared together. In some embodiments, the motors may be connected via a gear (e.g., a spur gear), a stiff belt, or another suitable arrangement. The first and second motors may be driven with independent drive amplifiers, although the motors may be driven via the same drive amplifier in some embodiments.

In some embodiments, the velocities (e.g., speeds) of the first and second motors may be bound together, such as with low stiffness binding. For example, the velocities of the first and second motors, and the output, may be proportional to one another. In some embodiments, the speeds of the first and second motors may be determined by the gear ratio of the gearing of the torque booster, denoted by N(>1). For example, the torque booster may rotate N times faster than the speed rotor. In such embodiments, both motors may possess proportional speeds and add their output torques.

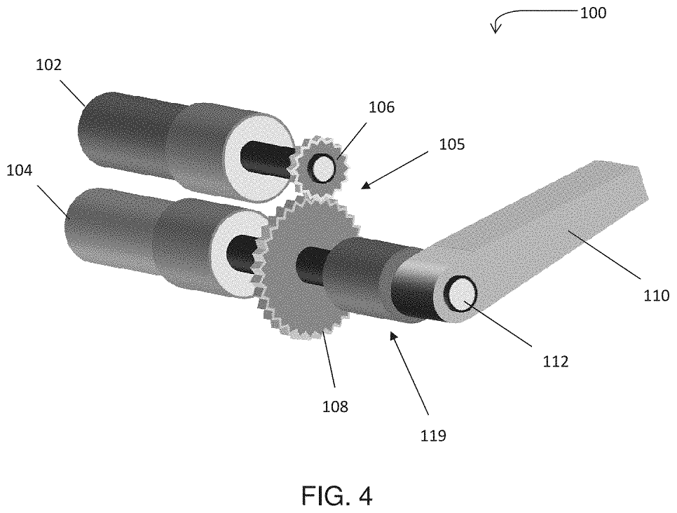

In some embodiments, the dual motor system may include an additional external gearing (see gearing 119 in FIG. 4). In such embodiments, the external gearing may be selected to appropriately match of the system load.

In some embodiments, the motor system is arranged to measure an output shaft velocity and to disconnect the first motor when an output speed is high. For example, in some embodiments, at high speeds, the first motor (e.g., the torque booster) generates a high back emf, which may exceed the voltage that its respective drive amplifier may generate. In such an example, at such high speeds, the drive amplifier cannot provide a high voltage and, as such, the torque booster may become a generator that consumes the mechanical power. Thus, in some embodiments, the torque booster may be electrically disconnected when the output speed is high, while in other embodiments, the first motor may be mechanically disconnected when the output speed is high. For example, in some embodiments, the torque booster may be disconnected at the speed where the torque booster is contributing no torque but has reached a high voltage limit (e.g., a cutoff speed). The inventors have appreciated that disconnection of the motor while current is flowing may cause an arc, which could potentially damage electronics. Accordingly, in some embodiments, the current to the torque motor may be diminished before disconnection of the torque booster.

In some embodiments, switching between the low-speed/high torque and the high-speed/low-torque modes may be achieved via only electric switches. For example, in some embodiments, the torque booster may be disconnected from its drive amplifier via one or more relays, couplers, and/or additional switching semiconductors at high speeds. In one such example, the relay may shut out the torque booster when its speed exceeds a certain threshold. As will be appreciated, once the torque booster is disconnected, no current may flow and thus, no power is taken, although the back emf voltage may still be high. In some embodiments, the power amplifier may include a H-bridge bi-polar amplifier. In some embodiments, the H-bridge bi-polar amplifier includes four switching semiconductors with additional diodes inserted between motor terminals and the individual switching semiconductors. As will be appreciated, other suitable numbers of semiconductors may be used in other embodiments.

In some embodiments, a control strategy for coordinating the two motors with an optimal power efficiency is provided, and the time-optimal control of the dual-motor hybrid dynamics may be addressed in the context of the “fall-catching” of the robotic assist system. For example, in some embodiments, the torque booster may be effective for rapid acceleration at a low speed, but is “disconnected” for further increasing the speed. This may be treated as a time-optimal control of the dual motor system.

FIG. 4 illustrates a dual-motor actuator 100 according to embodiments of the present disclosure. As shown in this view, the actuator may include a first motor, a torque booster 102, a second motor 104, a high-speed motor, a first gearing 105 having first and second gears 106, 108, and a second gearing 119. As shown in FIG. 4, the first gearing 105 (e.g., gears 106, 108) may connect the output shafts of the motors 102, 104. For example, the first gear 106 of the first gearing is connected to the torque booster while the second gear 108 of the first gearing is connected to the high-speed motor. As will be appreciated, the gearings may have other suitable arrangements in other embodiments. As shown in FIG. 4, the high-speed motor 104 may be directly connected to a load 110 via the second gearing 119 and an output shaft 112. Alternatively, the high-speed motor 104 may be directly connected to a load 110 via an output shaft 112, without a second gearing 119. The torque booster 102 may be connected to the output shaft of the high-speed motor via the first gearing 105. In this regard, both motors 102, 104 may be connected to the same output load 110.

In some embodiments, the speed of the first and second motors may be determined by the gear ratio of the first gearing 105 (e.g., first and second gears 106, 108), denoted by N (>1). In such embodiments, both motors may possess proportional speeds with their output torques being added together. In some embodiments, the gear ratio of the second gearing 119 is selected to appropriately match the system load, while the gear ratio of the first gearing 105 (e.g., gears 106, 108) determines how diverse speed ranges of operation may be covered with the two motors. In some embodiments, the torque booster rotates N times faster than the high-speed rotor.

In some embodiments, the gearing of the torque booster of the dual-motor actuator may possess two angular velocities, which may correspond to the velocities of the shafts of the first and second motors (e.g., the booster shaft and the output shaft). In some embodiments, to reduce the inertial load in the high-speed, low torque mode, a lightweight gearing may be used for the torque booster. In some embodiments, this may include plastic gears.

In some embodiments, the dynamics for the dual-motor system may arise from combining two instances of DC motor dynamics, with the dynamics of a gearbox used to combine them. In some embodiments, the inertia and friction contributions of the torque booster motor may be magnified by gear reduction. For example, inertia and viscous damping friction may both be magnified by N², and Coulomb friction may be magnified by N. In some embodiments, the magnification of these loads by the gear reduction may be a primary physical constraint preventing use of an arbitrary high gear ratio N.

As will be appreciated, although gearings are shown for connecting the first and second motors, in other embodiments, the system may have other suitable arrangements. For example, in some embodiments, a stiff belt may be used to connect the first motor (e.g., the torque booster) to the drive shaft.

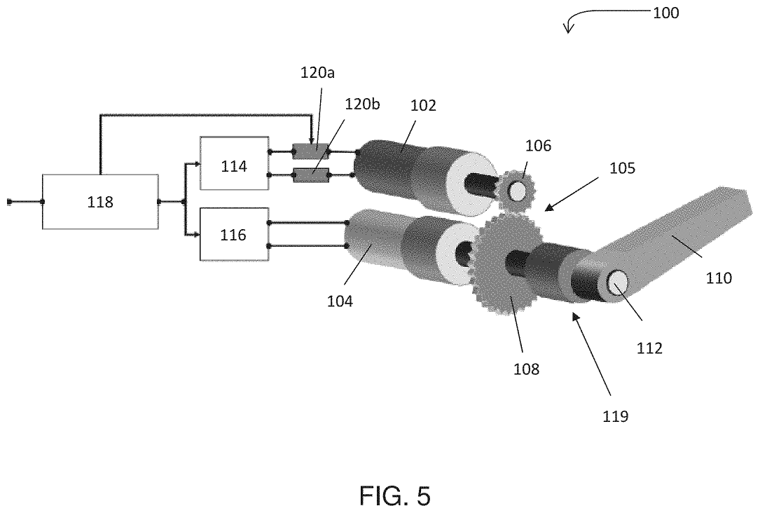

As shown in FIG. 5, in some embodiments, each motor may be connected to a respective drive amplifier. For example, the torque booster 102 may be connected to a first drive amplifier 114 while the high-speed motor 104 is connected to a second drive amplifier 116. As will be appreciated, more or fewer drive amplifiers may be used in other embodiments. In some embodiments, each drive amplifier may control current flowing to the respective motor. As shown in FIG. 5, each of the drive amplifiers may be connected to a coordination controller 118.

In some embodiments, the controller may control the two motors to provide a control input with two internal degrees of freedom. In some embodiments, the first degree of freedom may be used to control actuator output, such as velocity, torque, and/or impedance. In some embodiments, at a given operation velocity, any torque (e.g., within speed-dependent limits) may be easily commanded. In some embodiments, a torque command may be achieved through current control, given the proportionality of lossless output torque and motor current. In some embodiments, the speed-dependent torque limits may be those provided by the voltage limits of the overall system's battery or power supply.

In some embodiments, the second degree of freedom may be used to balance motor contribution, such as power efficiency maximization and/or voltage limit enforcement. The dual-motor actuator also may control an external degree of freedom, as it only has a single output shaft. In some embodiments, one of the internal degrees of freedom may be dedicated to providing the specified torque to the external degree of freedom, while the other internal degree of freedom may be used to adjust how the tow motors share the torque. In this regard, under a torque-sharing policy, this degree of freedom may be used to maximize power efficiency at each operating point.

With respect to power efficiency, in some embodiments, the motors may be both voltage limited, which may impose limits on both the ability to maintain an optimal current ratio and on the overall torque. In this regard, the torque booster motor may reach its voltage limit well before the direct-drive (e.g., high speed) motor.

In some embodiments, the booster motor may be at its voltage limit. In such embodiments, the booster voltage may be saturated. In some embodiments, this mode may be referred to as a saturation mode. In some embodiments, the maximum speed achievable while in the saturation mode may be less than the no-load speed of the direct-drive motor alone. In some embodiments, to achieve certain speeds, it may be necessary for the voltage limit on the booster motor to be relaxed. In some embodiments, this may be achieved via electrically disconnecting the booster motor. In some embodiments, this mode may be referred to as a disconnection mode.

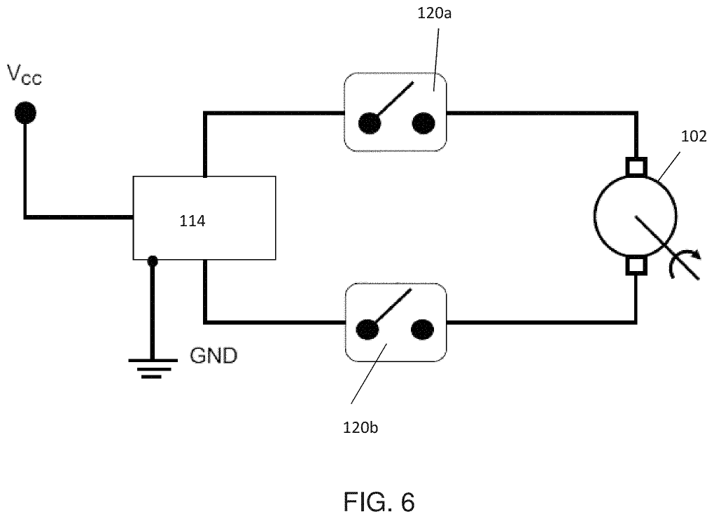

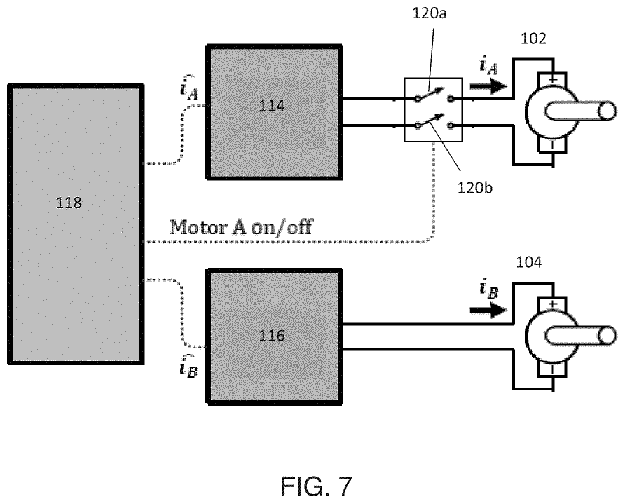

In some embodiments, as shown in FIG. 5, a pair of relays 120a, 120b may be inserted between the torque booster 102 and the respective drive amplifier 114. For example, the relays may be located between the motor leads and the drive amplifier. In some embodiments, the relays may shut out the torque booster when the speed of the torque booster exceeds a threshold level. In some embodiments, the coordination control may be arranged to track the speed of each of the first and second motors and directs the relays to shut out the torque booster when the speed of the torque booster reaches the threshold level. In some embodiments, once the motor is disconnected, no current flows and no power is taken. FIGS. 6 and 7 illustrates electrical disconnecting of the torque motor 102 via the relays. As shown in these figures, the relays 120a are openable to stop current from travelling to the torque motor 102 from the drive amplifier 114.

As will be appreciated, although the relays are shown as being positioned between the torque motor and the respective drive amplifier, in other embodiments, one or more relays may be positioned in another suitable portion of the circuit.

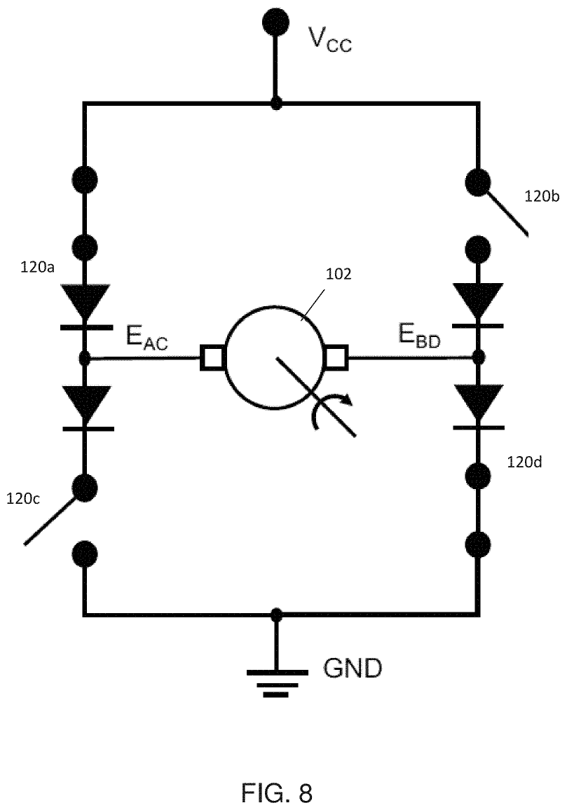

FIG. 8 illustrates another arrangement for electrically disconnecting the torque motor in the dual motor system. As shown in this figure, four diodes (122a-122d) may be inserted between the torque motor and the drive amplifier. For example, four diodes may be inserted between the motor leads and the four switching semiconductors of a H-bridge drive amplifier. In some embodiments, the gates may be selectively opened to prevent current from flowing through the circuit. For example, the first and fourth diodes may be open, and the second and fourth diode bridges may be opened (e.g., off) to prevent current flow. As with the above, with no current, and no power generation, there may be no burden on the high-speed motor, even if the output speed exceeds the range where the torque booster can contribute torque. As will be appreciated in view of the above, the torque booster may remain mechanically connected to the load at all times even when the motor is switched on and off via the H-bridge gates to switch the motor back to the low-speed, high-torque mode. As will be further appreciated in view of the above, the diodes may be inserted in other suitable location in the circuit, although they are shown between the motor leads and the switching semiconductors of the H-bridge.

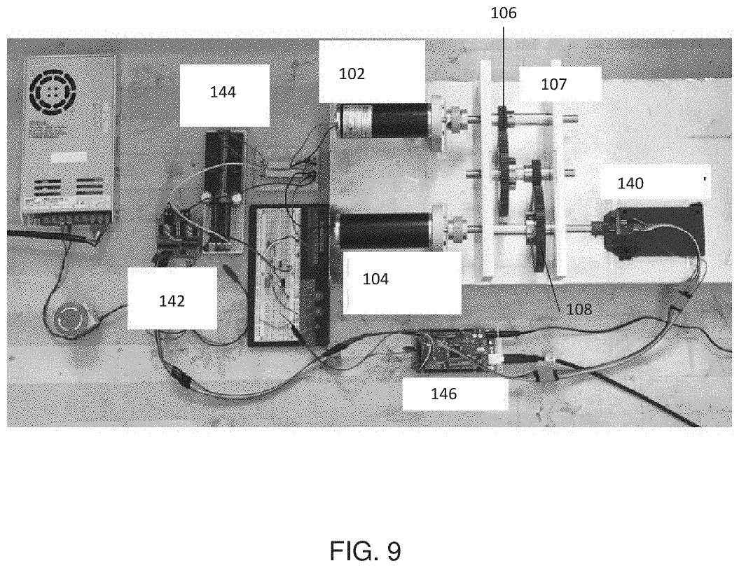

Another example of the dual-motor actuator is shown in FIG. 9. As shown in this view, the dual-motor actuator may include two 12V, 35W Crouzet 89-850-007 brushed DC motors (the booster motor labeled 102 and the high-speed motor labeled 104), and with two stages of KHK NSU1 plastic steel-core gears 107 (e.g., gears 106, 108), with pitch diameters of 100 millimeter and 32 millimeter, respectively. As with the embodiments above, each motor may include a respective gear (e.g., gears 106, 108). In some embodiments, no external inertia may be used to load the system, as the internal inertia of the system was found to be a sufficient load for the experiments. Angular position of the output shaft may be measured using an AMS AS5147P magnetic rotary encoder 140. The motors may be controlled with a DROK L298 dual H-bridge motor driver 142. In some embodiments, the motor driver 142 may include first and second drive amplifiers (e.g., similar to drive amplifiers 114, 116) for driving the motors. Connection and disconnection of the torque booster motor may be achieved using a pair of Comus 3350-4275-056 reed relays 144. In some embodiments, the reed relays may include first and second relays (e.g., similar to relays 120a, 120b). System control and data collection may be performed using an Arduino Mega 146 (e.g., a controller like controller 118).

In some embodiments, the system may include two direct current (DC) motors. As will be appreciated, although a brushed DC is shown and described in the example shown in at least FIG. 9 other suitable DC motors may be used in other embodiments. For example, dual-motor actuator may include a brushless DC motor. In other embodiments, the system may include an AC motor. In some embodiments, the system may include a non-electric motor, although the control system may differ in other embodiments. The system may include the same type of motor in some embodiments, although the system may include different motors in other embodiments.

As will be appreciated, although an encoder is shown for measuring speed, it will be appreciated that in other embodiments, other suitable arrangements for sensing speed, transmitting the information, to a controller, and then switching to electrically disconnect the booster motor.

In some embodiments, the motor system does not include any additional actuators than those shown in the figures. For example, the system includes only the first and second motors (e.g., torque booster and speed motor). As will be appreciated, systems may be designed with additional actuators included.

In some embodiments, an algorithm may be designed to control the system. In some embodiments, the algorithm includes a first sharing paradigm arranged to control a ratio between the torque motor current and the speed motor current such that it is appropriate for the desired speed range. In some embodiments, the first paradigm may ensure that zero current is flowing through the torque booster once the threshold speed, also referred to as a disconnection speed, has been reached. In some embodiments, it also may ensure that the torque motor is participating significantly at low speeds.

The algorithm also may include a second sharing paradigm, to maximize power efficiency while respecting the voltage limits of the motors. In some embodiments, boundaries of optimization are selected, and limits to voltages of both motors may be supplied. In some embodiments, application of boundaries may create a torque-speed envelope, within which the actuator can operate. In some embodiments, the algorithm also may enforce that the motors do not oppose in current.

In some embodiments, the algorithm design includes implementing robot-level control, with speed-dependent torque limits. In some embodiments, a standard feedback control may be used, but with output torque limited by a threshold which varies with speed.

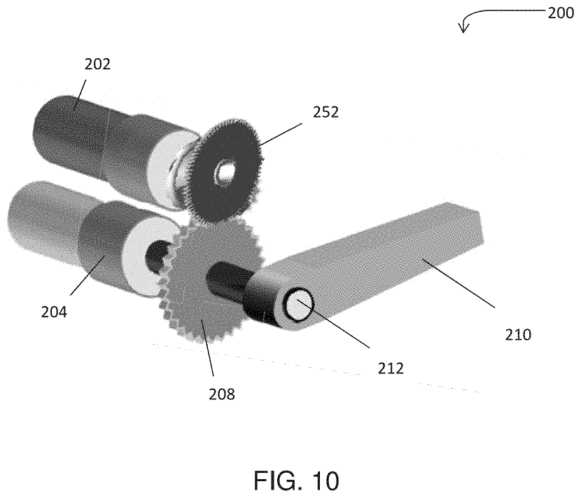

According to other embodiments herein, the torque booster may be mechanically disconnected during use. In some embodiments, as shown in FIG. 10, the torque booster may be disconnected via a centripetal clutch 252. As will be appreciated, the systems may include similar gearings to that of the systems that are electrically disconnected. The systems also include two motors (e.g., a torque booster 202 and a high-speed motor 204) that are connected to the gearing. In some embodiments, the system is arranged to mechanically isolate the torque booster when the motor reaches the threshold speed such that the motor does not act as a generator and consume mechanical power.

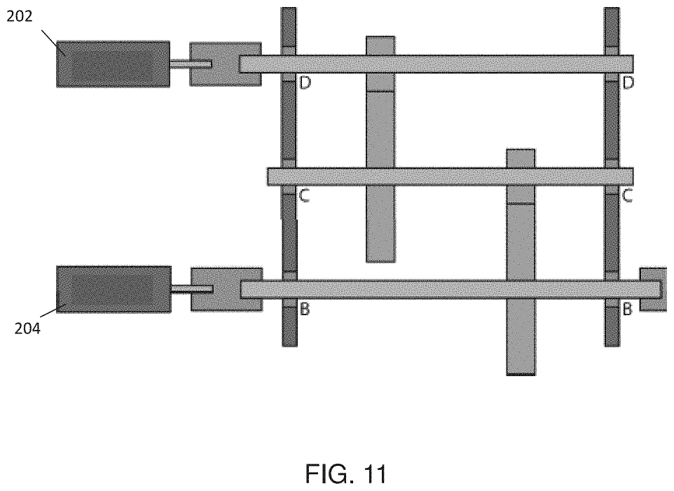

In some embodiments, the mechanical disconnection also may include a gearbox design (see, e.g., FIG. 11), In some embodiments, the gearbox design may include a centripetal clutch.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A motor system comprising:
a first motor having a first gear ratio;
a second motor having a second gear ratio lower than the first gear ratio;
a drive shaft, the first and second motors being connected to an output load via the drive shaft;
wherein the motor system is arranged to electrically and/or mechanically disconnect the first motor when a speed of the first motor is greater than or equal to a threshold speed.

2. The motor system of claim 1, further comprising a first drive amplifier arranged to drive the first motor.

3. The motor system of claim 2, wherein the motor system is arranged to electrically and/or mechanically disconnect the first motor from the first drive amplifier.

4. The motor system of claim 2, further comprising a second drive amplifier arranged to drive the second motor.

5. The motor system of claim 1, wherein the motor system is arranged to measure an output shaft velocity and electrically and/or mechanically disconnect the first motor when the output speed is high.

6. The motor system of claim 1, further comprising one or more gearings for connecting the first and second motors.

7. The motor system of claim 6, wherein the one or more gearings includes a first gearing having first and second gears, wherein the first gear is attachable to the first motor and the second gear is attachable to the second motor.

8. The motor system of claim 1, wherein the first and second motors include proportional speeds.

9. The motor system of claim 1, wherein the first motor is a torque booster and the second motor is a high speed motor.

10. The motor system of claim 1, wherein the first motor is electrically disconnected via one or more relays, couplers, and additional switching semiconductors.

11. The motor system of claim 10, wherein the first and second motors remain connected when the first motor is electrically disconnected from the system.

12. The motor system of claim 1, wherein the first motor is mechanically disconnected via a clutch.

13. The motor system of claim 1, wherein each of the first and second motors include direct current (DC) motors.

14. The motor system of claim 1, wherein the motor system includes an actuator.

15. An electric motor system comprising:
a first motor having a first gear ratio and driven via a first drive amplifier;
a second motor having a second gear ratio lower than the first gear ratio, the second motor being driven via a second drive amplifier;
a drive shaft, wherein the first and second motors are connected to an output load via the drive shaft;
wherein the motor system is arranged to measure an output shaft velocity and electrically disconnect the first motor when an output speed is greater than or equal to a threshold speed.

16. The electric motor system of claim 15, wherein the motor system is arranged electrically disconnect the first motor when the output speed is high.

17. The electric motor system of claim 15, wherein the first motor is a torque booster and the second motor is a speed motor.

18. The electric motor system of claim 15, wherein the first motor is electrically disconnected from the first drive amplifier using at least one of relays, couplers, and additional switching semiconductors.

19. The electric motor system of claim 18, wherein the first motor is electrically disconnected via a power amplifier having a H-bridge bi-polar amplifier.

20. The electric motor system of claim 19, wherein the H-bridge includes four switching semiconductors and four diodes inserted between motor terminals and the respective switching semiconductor.

21. The electric motor system of 20, wherein the diodes are arranged to prevent current through the first motor from occurring at high output speeds.

22. A method of operating a motor system having a first motor with a high gear ratio, a second motor with a low gear ratio, and a drive shaft, the first and second motors being connected to an output load via the drive shaft, the method comprising:
electrically and/or mechanically disconnecting the first motor when a speed of the first motor is greater than or equal to a threshold speed.

23. The method of claim 22, wherein the first motor includes a torque booster and the second motor is a speed motor.

24. The method of claim 22, further comprising, before the step of disconnecting, measuring a speed of the first motor.

25. The method of claim 22, wherein the step of electrically disconnecting the first motor includes electrically disconnecting the first motor via at least one of relays, couplers, and additional switching semiconductors.

26. The method of claim 25, wherein the step of electrically disconnecting includes stopping current from travelling to the first motor.

27. The method of claim 22, wherein the step of mechanically disconnecting includes mechanically disconnecting via a clutch.
